(19) United States
(12) Patent Application Publication
(10) Pub. No.: US 2023/0354840 A1
(43) Pub. Date: Nov. 9, 2023

(54) FIBRE-BASED OLEOGEL

(71) Applicant: Agency for Science, Technology and Research, Singapore (SG)

(72) Inventor: Pui Yeu Phoon, Singapore (SG)

(73) Assignee: Agency for Science, Technology and Research, Singapore (SG)

(21) Appl. No.: 18/246,135

(22) PCT Filed: Sep. 21, 2020
(86) PCT No.: PCT/SG20/50537

§ 371 Date: Mar. 21, 2023

(51) Int. Cl. A23D 9/04; A23D 9/007; A23D 7/005

(52) U.S. Cl. CPC A23D 9/04; A23D 9/007; A23D 7/0056

(57) ABSTRACT

The present invention relates to a method for the manufacture of an oleogel, comprising a) homogenising an aqueous dispersion of natural food fibre to develop viscosity, b) shear-mixing the aqueous fibre dispersion with liquid edible oil at room temperature to form an emulsion, and c) subjecting the emulsion to freeze-drying to remove the water. In some embodiments, the natural food fibre is citrus fibre or nata de coco fibre mix. The invention further relates to an edible fibre-based oleogel obtained by the method, as well as food products comprising the oleogel and/or based upon the oleogel.

### FIELD OF THE INVENTION

The present invention relates to a method for the manufacture of an oleogel. The invention further relates to an edible fibre-based oleogel obtained by the method, as well as (food) products comprising the oleogel and/or based upon the oleogel.

### BACKGROUND

The present invention is to be understood in light of what has previously been done in the field. However, the following discussion is not an acknowledgement or an admission that any of the material referred to was published, used or part of the common knowledge of the skilled person as at the priority date of the application.

Solid fats and products such as spreads, confectionery fats, and shortenings form an indispensable part of the modern diet. Such ingredients rely on the significant presence of saturated or hydrogenated fats for their solid structure and in turn material functionality. This solidity arises from the assembly of the saturated fats, in the form of triacylglycerols, into a crystal network which entraps the liquid component of the fat from oozing out of the matrix [Co E. D., and Marangoni A. G., in Edible Oleogels (Second Edition), eds. A. G. Marangoni and N. Garti, AOCS Press, 2018, pp. 1-29]. In view of the recognised deleterious effects of saturated fatty acids on the blood lipoprotein profile [DiNicolantonio J. J., and O'Keefe J. H., Open Heart, 2018, 5: e000871], the reduction in their intake is typically advocated by today's dietary guidelines [Singapore Ministry of Health, Lipids. MOH Clinical Practice Guidelines February 2016]. This opens up the opportunity for edible oleogels, in which structuring agents are employed to entrap liquid oil in a three-dimensional network. Many original studies and reviews have been reported on oleogels, and as Martins et al [Martins A. J., et al., Food & Function, 2018, 9: 758-773] aptly put across, in most cases the underlying mechanisms involve the re-assembly of gelating structurants above the melting or glass transition temperature. A highly researched category of structurants is food-grade cellulosic derivatives, such as ethyl cellulose and hydroxypropyl methylcellulose. However, both ingredients are not natural, and with ethyl cellulose there is the need for heating beyond 140° C. which brings the probable issue of oil oxidation. The potential for the use of natural cellulose in oleogelation, on the other hand, has been scarcely investigated. Totosaus et al [Totosaus A., et al., Grasas y Aceites, 2016, 67: e152] studied the use of α-cellulose together with mono- and diacetyl tartaric acid esters to make a soybean oil oleogel, inevitably using high heat to melt the emulsifiers in the process. Others have created shortening by agitating liquid oil and cellulose fibre extracted from vegetative sources under heat, but not without the use of a minute quantity of hard stock (i.e. crystalline fat) [Higgins N. W., and Daniels R. L., EP Patent, EP2568818A1, 2011].

Although cellulose has several hydroxyl groups and great hydrogen bonding ability, their chains do have amphiphilicity, which is often overlooked due to the inadequate awareness of their potential for hydrophobic interactions that could be harnessed [Alves L., et al., Colloids and Surfaces A: Physicochemical and Engineering Aspects, 2015, 483: 257-263; Medronho B., and Lindman B., Advances in Colloid and Interface Science, 2015, 222: 502-508]. As supported by molecular dynamics simulation [Miyamoto H., Rein D. M., et al., Cellulose, 2017, 24: 2699-2711], the cellulose chains could participate in hydrophobic interaction with non-polar molecules via the CH groups on the glucose pyranoses, while the hydroxyl groups could form hydrogen bonds with water molecules. Only a few studies have reported o/w emulsion-making by employing the amphiphilic nature of solubilised cellulose chains, which are first dissolved molecularly in the ionic liquid 1-ethyl-3-methylimidazolium acetate and then regenerated from such a solution into the hydrogel form [Napso S., Rein D. M., et al., Langmuir, 2018, 34: 8857-8865; Napso S., Rein D. M., et al., Colloids and Surfaces B: Biointerfaces, 2016, 137: 70-76; Rein D. M., Khalfin R., and Cohen Y., Journal of Colloid and Interface Science, 2012, 386: 456-463]. More commonly, cellulose is utilised in the particulate form, e.g. commercial colloidal microcrystalline cellulose (i.e. Avicel®) to stabilise o/w Pickering emulsions [Garti N., Food emulsifiers: Structure-reactivity relationships, design, and applications, CRC Press, Boca Raton, 2002]. Avicel® colloidal microcrystalline cellulose is mixed with the synthetic, water-soluble carboxymethylcellulose, which serves as a processing aid to keep the microcrystalline cellulose chains from re-association during hydration and shear-activation.

There is a need to develop improved fat replacers via edible oil structuring in oleogel compositions.

### SUMMARY OF THE INVENTION

It has surprisingly been found that an oleogel, containing only natural food fibres and liquid vegetable oil, can be developed by increasing the surface activity of the fibres using a non-thermal method. These oleogels do not oil off under low compression force. The presence of fibre was found to disrupt fat crystallisation, leading to proportionately more crystal species that were less stable. However, the true melting point of fat was not significantly altered. Despite greater disruption, oleogels made with longer and/or more extensive fibres were mainly firmer and capable of keeping the oil in solid oleogel form, even under elevated temperatures.

According to a first aspect, the present invention provides a method of preparing an edible oleogel comprising:

a) homogenising an aqueous dispersion of natural and/or naturally derived food fibre a plurality of times to develop viscosity;

b) shear-mixing the aqueous fibre dispersion with liquid edible oil at room temperature, to form an emulsion; and

c) subjecting the emulsion to freeze drying to remove the water.

In some embodiments, the viscosity of the aqueous fibre dispersion is increased by increasing a homogenising pressure and/or by repeating the homogenisation in step a).

In some embodiments, step a) comprises:

i) pre-combining a powder of natural and/or naturally derived food fibre with water and shear-mixing the combination to form a crude dispersion;

ii) homogenising the combination of step i) in a 2-stage homogeniser whereby the second stage pressure is lower than the first stage pressure to form an aqueous fibre dispersion having a viscosity. In general practice, the setting of a lower pressure in the second stage of homogenising is meant to enhance the disruptive forces on the liquid feed.

In preferred embodiments, the homogenising in step a) is performed at room temperature.

Advantageously, heating is not required in step b).

In some embodiments, the viscosity of the aqueous fibre dispersion is increased by increasing a homogenising pressure and/or by repeating the homogenisation step aii). For example, Table 1 shows that for a 1.5% citrus fibre of commercial product code 100M40, 3 homogenising passes at 120 bar of pressure produced a fibre dispersion with an average viscosity of about 107 mPa s which increased to about 398 mPa s when 10 homogenising passes were performed. When 3 homogenising passes were performed at 50 bar of pressure the fibre dispersion had an average viscosity of about 38.6 mPa·s.

In some embodiments, the homogenising pressure to form the aqueous fibre dispersion is in the range between 25 bar and 160 bar, preferably between 50 bar and 140 bar.

In some embodiments, the total homogenising pressure in step aii) is in the range of about 50 bar to about 140 bar and the pressure applied in the second stage is in the range of about 5% to about 20% of the total pressure. Preferably, the second stage is about 10% of the total pressure.

An alternative to the step a) homogenisation in a 2-stage homogeniser is to use microfluidization. An example of a microfluidizer is the M700 Series Biopharma Microfluidizer® (Microfluidics Corp. MA, USA).

The purpose of the sheer-mixing steps is to evenly mix the food fibre in water to form a dispersion and/or the oil into the homogenised fibre dispersion to form an emulsion. It would be understood that the adequacy of rpm and time is dependent on other experimental factors, for instance the ratio between the dimension of the rotor of the shear mixer and the diameter of the sample container containing the sample to be shear-mixed. In some embodiments, the shear-mixing is performed at about 6000 rpm, or higher, for about 5 minutes, or more. In some embodiments the shear-mixing is performed at 6000 rpm for 5 minutes.

At the laboratory scale, 6000 rpm may be used with a rotor having a diameter of about 3 cm to process a volume up to about 200 mL. For industrial scale, the setup for high shear mixing is different and involves circulating the liquid through an in-line mixer in a continuous manner. The adequacy of the power of an industrial mixer depends of the volume to process and the flow rate.

In some embodiments, step c) comprises subjecting the emulsion to freeze-drying, for instance, via liquid nitrogen freezing, and then freeze drying it under a vacuum of less than 0.1 mbar to remove the water. The emulsion may be freeze-dried with or without microwave-assistance. It would be understood there may be alternative ways of freeze-drying the fibre and oil emulsion. This step c) removes water while preserving structural order, in order to create a solid-like oleogel that is stable against microbial spoilage (due to lack of water).

In some embodiments, the food fibre is an insoluble food fibre or a mixture of insoluble and soluble food fibre. In some instances, a separate soluble fibre may need to be added to an insoluble fibre to associate with the insoluble fibre chains, so as to weaken their inter-chain hydrophobic interactions and facilitate their dispersibility in water.

In some embodiments, the food fibre is a fruit fibre, vegetable fibre, or a bacterial cellulose fibre. In some embodiments, the food fibre is a citrus food fibre or nata de coco fibre and a soluble fibre, such as corn fibre. A suitable bacterial cellulose fibre is produced by Acetobacter.

In some embodiments, the total fibre concentration in the aqueous fibre dispersion is in the range of about 1% to about 5% (w/w), preferably about 1% to about 3% (w/w), more preferably about 1.5% to about 2.0% (w/w).

In some embodiments, for 2.0% and 1.5% (w/w) fibre dispersions, the preferred dispersion-to-oil ratio is set at 2.0:1 and 2.7:1 (w/w), respectively. Under such conditions, kinetically metastable emulsions are created.

In some embodiments, an oleogel with the rheology of a breakfast spread can be obtained using a citrus fibre (at a powder particle size below 12 μm) at 2.0% (w/w), and by homogenising at a total pressure of 50±5 bar with 3 passes during the preparation of the aqueous fibre dispersion.

In some embodiments, an oleogel with temperature tolerance as high as 70° C. can be obtained using a citrus fibre (at a powder particle size below 74 μm) at 1.5% (w/w), and by homogenising at a total pressure of 50±5 bar with 3 passes during the preparation of aqueous fibre dispersion.

In some embodiments, the liquid edible oil is selected from a group comprising canola oil, corn oil, flaxseed oil, palm oil, olive oil, soybean oil, safflower oil, peanut oil, grape seed oil, sesame oil, argan oil, rice bran oil, avocado oil, mustard oil, algal oil, echium oil, squid oil, salmon oil, halibut oil, fractions and mixtures thereof. In some embodiments, the liquid edible oil is refined liquid palm oil or olive oil.

According to the invention, there is no requirement for utilizing high temperature, or the addition of other emulsifier(s), or surfactant(s) or crystalline/hydrogenated/solid fat, to help stabilise the emulsion, or aqueous gelation for the oleogel structure. Moreover, there is no need for chemical modification or a second compatible biopolymer to reinforce the skeletal network holding the oil, for instance as in the cases with cross-linked protein and protein-carbohydrate complexation. The method of the present invention does not require harsh/non-edible chemicals and uses only materials naturally existing or derived from nature.

According to a second aspect, the present invention provides an edible oleogel obtained by the method of the first aspect of the invention wherein the homogenised aqueous fibre dispersion is shear-mixed with liquid edible oil at room temperature, preferably at a minimum of 6000 rpm for at least 5 minutes to form an emulsion and wherein the oleogel does not contain any emulsifier, surfactant or food polymer in addition to the food fibre and the liquid edible oil is selected from canola oil, corn oil, flaxseed oil, palm oil, olive oil, soybean oil, safflower oil, peanut oil, grape seed oil, sesame oil, argan oil, rice brain oil, algal oil, echium oil, squid oil, salmon oil, halibut oil, fractions and mixtures thereof.

In some embodiments, the edible oleogel obtained by the method of the first aspect of the invention, comprises an insoluble fibre component, a soluble fibre component and edible oil, wherein the oleogel contains up to about 96% (w/w) oil content.

In some embodiments, the insoluble fibre to oil content is up to about 1:61 (w/w) after excluding residual bound water.

In some embodiments, the insoluble fibre component is in the range of 0.62% to 0.83% (w/w), and the soluble fibre component is in the range of 0.52% to 1.18% (w/w).

According to a third aspect, the present invention provides use of the oleogel of the second aspect to prepare a food product.

In some embodiments, the oleogel replaces at least part of a solid or semi-solid fat in the food product.

In some embodiments, the food product is selected from baked goods such as cookies and cakes; spreads such as margarine or bakery margarine, breakfast spreads, and chocolate spreads; chocolate and fillings.

### BRIEF DESCRIPTION OF THE FIGURES

FIG. 1 shows an epifluorescence microscopy image of a jammed emulsion created from refined liquid palm oil and 2% citrus fibre (of commercial product code 100M20) dispersion (26.6 mPa·s at ˜23° C.), stained by Nile Red dye. The image was taken 4 hours after emulsion preparation, and converted to grayscale. The bright regions show the stained boundaries of emulsion droplets which are jammed together.

FIG. 2 shows superimposed images of fibre-based oleogel samples acquired by transmitted differential interference contrast (DIC) microscopy and confocal laser scanning microscopy (CLSM), and converted to grayscale (A-D). DIC distinctly captures the fibre networks. Separate brightness-adjusted CLSM images of the same scanned areas, which portray the distribution of Nile Red-stained oil in the oleogel samples as bright regions, are also included as inserts. The oleogel samples were derived from jammed emulsions comprising refined liquid palm oil and (A) 1.5% citrus fibre 100M40 dispersion (38.6 mPa·s); (B) 1.5% citrus fibre 100M20 dispersion (31.0 mPa·s); (C) 2.0% citrus fibre 100M20 (26.6 mPa·s); and (D) 2.0% Nata de coco fibre mix dispersion (24.6 mPa·s). The stated viscosities were measured at ˜23° C. The dark regions observed were artifacts owing to regions which were thick with sample material.

FIG. 3 shows a representative differential scanning calorimetry (DSC) melting thermograms of refined liquid palm oil and fibre-based oleogel samples, at 5° C.·min⁻¹ rate. The samples were priorly solidified by cooling at 5° C.·min⁻¹. Oleogel samples 3, 4, 5, and 6 were created by a jammed emulsion-templated method, while oleogel sample 2 was created by a cryogel foam-templated method. All the oleogel samples had 96% oil (weight basis) and the same insoluble fibre to oil ratio of 1:61 (weight basis). The fibre suspensions used in creating the oleogel samples were all shear-activated at 50 bar, except in sample 4 (140 bar). Details of the fibre suspensions are explained in Table 4.

FIG. 4 shows results of samples from the spreadability test performed using the texture analyser. (A) Representative force-distance curves. (B) Measured firmness. (C) Work of penetration by the advancing probe from the integrated force-distance curves. (D) Photograph of the samples after the spreadability test, taken using the camera function of a smartphone, in grayscale. The annotating numbers refer to : (1) Oleogel created from refined liquid palm oil and 1.5% citrus fibre 100M40 dispersion (38.6 mPa·s); (2) Oleogel created from refined liquid palm oil and 1.5% citrus fibre 100M20 dispersion (31.0 mPa·s); (3) Oleogel created from refined liquid palm oil and 2.0% citrus fibre 100M20 dispersion (26.6 mPa·s); (4) Oleogel created from refined liquid palm oil and 2.0% Nata de coco fibre mix dispersion (24.6 mPa·s); (5) Oleogel created from refined liquid palm oil and 2.0% citrus fibre 100M20 dispersion (38.0 mPa·s); (6) Oleogel created from olive oil and 2.0% citrus fibre 100M20 dispersion (38.0 mPa·s); and (7) Nutella® hazelnut spread with cocoa. The error bars represent absolute error. The oleogel samples were prepared by the jammed emulsion-templated method and, assuming negligible bound water, contained 96% oil (weight basis). The stated viscosities were measured at ˜23° C.

FIG. 5 shows photographs of fibre-based oleogel samples derived from jammed emulsions, heated to different temperatures, in grayscale. The pictures are adjusted in brightness and contrast to the same extent. Pictures framed by a bright border infer apparent melting behaviour in the sample. The annotating numbers refer to: (1) Oleogel created from refined liquid palm oil and 1.5% citrus fibre 100M40 dispersion (38.6 mPa·s); (2) Oleogel created from refined liquid palm oil and 1.5% citrus fibre 100M20 dispersion (31.0 mPa·s); (3) Oleogel created from refined liquid palm oil and 2.0% citrus fibre 100M20 dispersion (26.6 mPa·s); (4) Oleogel created from refined liquid palm oil and 2.0% Nata de coco fibre mix dispersion (24.6 mPa·s); (5) Oleogel created from refined liquid palm oil and 2.0% citrus fibre 100M20 dispersion (38.0 mPa·s); and (6) Oleogel created from olive oil and 2.0% citrus fibre 100M20 dispersion (38.0 mPa·s). The stated viscosities were measured at ˜23° C. The oleogel samples contained 96% oil (weight basis), assuming negligible bound water.

FIG. 6 shows photographs of fibre-based oleogel samples heated to 70° C., adjusted in brightness and contrast to the same extent, in grayscale. The samples were created from refined liquid palm oil and 1.5% citrus fibre 100M40 dispersion (38.6 mPa·s at ˜23° C.). Sample 1 was prepared by a jammed emulsion-template method; sample 1F was made by a cryogel-foam template method. The bright border framing the picture of sample 1F infers apparent melting behaviour.

FIG. 7 shows photographs showing potential applications of fibre-based oleogel, in grayscale. (A) Breakfast spread, composed solely of the oleogel sample created from refined liquid palm oil and 2.0% citrus fibre 100M20 dispersion (26.6 mPa·s). (The photograph was taken using the camera function of a smartphone.) (B) Shortening-replacer composed solely of the oleogel sample made from refined liquid palm oil and 1.5% citrus fibre 100M40 dispersion (38.6 mPa·s), laminated in multiple alternating layers into a three-quarter puff pastry dough by sheeting. The stated viscosities were measured at ˜23° C.

### DETAILED DESCRIPTION OF THE INVENTION

Bibliographic references mentioned in the present specification are for convenience listed in the form of a list of references and added at the end of the examples. The whole content of such bibliographic references is herein incorporated by reference.

### Definitions

Certain terms employed in the specification, examples and appended claims are collected here for convenience.

As used herein, “a,” “an,” “the,” “at least one,” and “one or more” are used interchangeably. The terms “comprises,” “includes,” and variations thereof do not have a limiting meaning where these terms appear in the description and claims. Thus, for example, an aqueous composition that includes particles of “a” natural food fibre can be interpreted to mean that the composition includes particles of “one or more” natural food fibres.

As used herein, the recitations of numerical ranges by endpoints include all numbers subsumed in that range (e.g., 1 to 5 includes 0.5, 1, 1.5, 2, 2.75, 3, 3.80, 4, 5, etc.). For the purposes of the invention, it is to be understood, consistent with what one of ordinary skill in the art would understand, that a numerical range is intended to include and support all possible subranges that are included in that range. For example, the range from 1 to 100 is intended to convey from 1.01 to 100, from 1 to 99.99, from 1.01 to 99.99, from 40 to 60, from 1 to 55, etc.

As used herein, the recitations of numerical ranges and/or numerical values, including such recitations in the claims, can be read to include the term “about.” In such instances the term “about” refers to numerical ranges and/or numerical values that are substantially the same as those recited herein and may be represented by “˜”.

As used herein, the term “comprising” or “including” is to be interpreted as specifying the presence of the stated features, integers, steps or components as referred to, but does not preclude the presence or addition of one or more features, integers, steps or components, or groups thereof. However, in context with the present disclosure, the term “comprising” or “including” also includes “consisting of”.

Generally, oleogels are gels in which lipid or oil is entrapped in a network. For the disclosed invention, the term “oleogel” herein refers to a gel having a continuous edible oil phase with the natural food fibres uniformly dispersed to entrap the oil.

The term “food product” herein refers to edible products comprising the oleogel and suitably also containing one or more additional ingredients such as selected from carbohydrates (e.g. starch and non-starch, sugars), protein, dietary fibre, water, flavouring agents such as salt, colorants, vitamins and minerals. Typically, the food product contains at least about 1% by weight of the oleogel, for example at least about 5% by weight, at least about 10% by weight or at least about 15% by weight of the oleogel. In some embodiments the food product contains less than 99% by weight of the oleogel, for example less than about 95% by weight of the oleogel. Examples of food products that can be prepared by using the present oleogel include baked goods such as cookies and cakes; spreads such as margarine (bakery margarine), breakfast spreads, and chocolate spreads; chocolate and fillings.

Jammed emulsions are characterized by random close packing of the dispersed phase droplets compressed together throughout the emulsion system.

Having now generally described the invention, the same will be more readily understood through reference to the following examples which are provided by way of illustration, and are not intended to be limiting as regards the scope of the present invention.

### EXAMPLE 1

### Materials and Methods

Citrus fibre powder samples CITRI-FI® 100M40 and 100M20, with particle size below 74 μm and 12 μm, respectively, were provided by Fiberstar, Inc. (River Falls, Wisconsin, U.S.A.). In both citrus fibre samples, the insoluble fibre content was 41.39% while the soluble fibre content was 34.74%. Nata de coco powder sample, with fibre only of insoluble type, was provided by Hainan Guangyu Biotechnology Co. Ltd. (Haikou, Hainan, China). Soluble corn fibre Promitor™ 90, containing at least 90% soluble fibre content, was supplied by Tate and Lyle PLC (London, England). Refined liquid palm oil and olive oil, with 61% and 73% total unsaturated fat content (weight basis), respectively, were purchased from a local supermarket. Nile Red fluorescent dye was purchased from Santa Cruz Biotechnology, Inc. (Santa Cruz, U.S.A.) through a local supplier. Absolute ethanol (EMSURE®ACS, ISO, Reag. Ph Eur) which was used for preparing Nile Red stock solution was bought from Merck (Darmstadt, Germany). In all the sample preparation, the minimal quality of water used was deionised water.

### Preparation of Aqueous Fibre Dispersion

Fibre powder was slowly dispersed into water and shear-mixed at minimum 6000 rpm for 5 min at room temperature using a Silverson L5M-A high shear laboratory mixer (Silverson, Chesham, England). The mixture was then further homogenised within ±5 bar error, using a two-stage Panda Plus 2000 homogeniser (Niro Soavi, GEA, Parma, Italy), to obtain the fibre dispersion. When the total targeted homogenising pressure was 50 bar, the second stage was set at 5 bar. When the total targeted homogenising pressure was 120-140 bar, the second stage was set at 10 bar.

### Preparation of Oleogel Samples

From Table 1, aqueous fibre dispersions of interest were carefully selected for preparing specific oleogel samples for comparison. The aqueous fibre dispersion was shear-mixed with either refined liquid palm oil or olive oil, at 6000 rpm for 5 min at room temperature, using the Silverson L5M-A high shear laboratory mixer. For 2.0% and 1.5% dispersions, the ratio of dispersion to oil was set at 2.0:1 and 2.7:1 (w/w), respectively. Under such conditions, kinetically metastable emulsions were created. The emulsions were transferred into 50-mL centrifuge tubes and quickly frozen via liquid nitrogen dipping, followed by freeze-drying in a Virtis benchtop 4K XL model freeze-dryer (SP Scientific, Warminster, Pennsylvania, U.S.A.). In each resultant oleogel sample, assuming negligible bound water, the oil content was 96% (w/w), and the ratio of insoluble fibre to oil was 1:61 (w/w).

Besides the emulsion-templated method, corresponding oleogel samples of the same contents were also created via a cryogel foam-templated method modified from Patel et al., [Patel, A. R., et al., RSC Advances 3: 22900-22903 (2013)] as comparator. Oleogel samples created as such were used for comparing how both methods influence the melting characteristics of oleogel. In the cryogel foam-templated method, the aqueous fibre dispersion of interest was first contained in 50-mL centrifuge tubes and freeze-dried and then liquid oil was added. The mixture was gently mixed via vortex-mixing to minimise physical disruption to the fibre network. The mixture was then allowed to stand overnight at room temperature, to allow as even a diffusion of oil as possible throughout the fibre network.

### Optical Determination of Surface/Interfacial Tension Between Aqueous Fibre Dispersion and Air/Oil

Surface/Interfacial tension was determined by pendant drop tensiometry, as discussed by Berry et al. [Berry, J. D., et al. Journal of Colloid and Interface Science 454: 226-237 (2015)]. The determination was done on an OCA15EC video-based contact angle measuring device (DataPhysics, Filderstadt, Germany), controlled by the software programme SCA20_U. The determination required finding a numerical fit of a theoretical drop shape, using the Young-Laplace equation, to the optically recorded pendant drop shape. The fibre dispersion to be tested was gently shaken or vortexed, and loaded into a disposable syringe with a needle of outer diameter 0.91 mm. The syringe was loaded onto the measuring device, with the needle positioned in air or immersed in refined liquid palm oil at room temperature. A total of 2 μL of the fibre dispersion was steadily dosed, μL by μL at a dosing rate of 0.1 μL·s⁻¹, into the air/oil to form a suspending pendant drop at the tip of the needle. Straight after which, and with the densities of the aqueous and air/oil phases keyed in at 0.9982 and 0.0012/0.93 g·cm³, respectively, surface/interfacial tension of the captured drop image was determined live by the software, over a duration of 5 min at one reading per second. The average of the last 20 readings was taken. Triplicate measurements were done.

### Measurement of Viscosity

Viscosity measurement was done in duplicates using the tuning fork vibro viscometer SV-10 (AND, Tokyo, Japan) [JIS Z 8803: 2011]. Each sample was gently mixed to ensure evenness before measurement. The volume of aliquot for each measurement in the sample vial was 10 mL. The viscosity reading was taken after it stayed stable for 5 seconds.

### Epifluorescence Microscopy Imaging of Emulsion Sample

A stock solution of 0.01% (w/w) Nile Red (Santa Cruz biotechnology, Santa Cruz, U.S.A.) in absolute ethanol (EMSURE® ACS, ISO, Reag. Ph Eur) (Merck, Darmstadt, Germany) was prepared. To 1 mL of emulsion prepared 4 h ahead, 32 μL of the Nile Red solution was added. The mixture was vortexed and allowed to stand for at least 10 min before imaging. Epifluorescence microscopy was performed on a BX53 upright microscope (Olympus, Tokyo, Japan) with a TRITC fluorescence filter, controlled using the cellSens programme software. The exposure was set at automatic, and image acquisition was done at 1920×1200 pixels.

### Differential Interference Contrast and Confocal Laser Scanning Microscopy Imaging of Oleogel Sample

Prior to freezing and freeze-drying, 1.50 to 2.43 g of the emulsion of interest was contained in an amber centrifuge tube and dosed with 2 μL solution of the Nile Red stock solution from Section 2.5.1. Freeze-drying was performed with the amber centrifuge tube wrapped in aluminum foil and covered in opaque cups. The foil and cups were pricked with few holes to allow the release of water vapour. As an extra precaution against sample bleaching by light, the freeze-dryer unit was covered in dark, light-proof cloths. After freeze-drying, the resultant oleogel sample contained 3 to 4×10⁻⁵% (w/w) of Nile Red.

Transmitted differential interference contrast (DIC) microscopy and confocal laser scanning microscopy (CLSM) were performed on an FV3000 RS inverted confocal laser scanning microscope (Olympus, Tokyo, Japan), using the software FV31S-SW (version 2.3.2). A cover-less Lab-tek 35 mm dish, with a 20 mm well and a No. 1.5 glass bottom (0.17-0.19 mm in thickness) marked with four quadrants, was used for imaging at 22° C. The oleogel sample was thinly spread onto the glass. During CLSM, the sample was excited with 561 nm laser beam and scanned by a galvo scanner in one-way direction at 8 μs per pixel. The laser percentage, high voltage, and gain settings were adjusted accordingly. DIC and CLSM images were collected in 512×512 pixels, superimposed, and adjusted in brightness and contrast using the image processing software Fiji (Fiji Is Just ImageJ).

### Measurement of Spreadability

The spreadability of oleogel samples was determined by a compression test using the TTC spreadability rig (comprising of a cone probe and precisely matched cone shaped product holder) on a TA.XT.plus Texture Analyser (Stable Micro Systems, U.K.) [Smewing, J. Texture analysis in action: the TTC spreadability (2019)], controlled 20 via the Exponent software (version 6.1.16.0). The load cell was 5 kg. Samples were run in duplicates. As a product reference, a commercial Nutella® hazelnut spread with cocoa was also measured. The sample was mildly stirred to ensure evenness, before filling into the product holder and flattened at the surface with a spread knife. The weight of the loaded oleogel sample was 7.03-7.63 g, while that of the loaded commercial spread was 8.88-9.05 g. The sample was left to equilibrate to 21.5-22.5° C. before measurement. The measuring settings were (i) starting distance between the cone probe and the product holder: 50 mm; (ii) test mode: compression; (iii) test speed: 3 mm·s⁻¹; (iv) target mode: distance; (v) trigger type: button; (vi) distance: 45 mm; and (vii) post-test speed: 10 mm·s⁻¹. In the settings, advanced options were set to “off”. During analysis of the obtained force-time curve, the in-built macro “Margarine-MAR1_P5” in the programme software was used to analyse two parameters: (i) firmness, which was the peak force of compression; and (ii) work of penetration, which was the work calculated to push the cone probe down 45 mm into the sample.

### Differential Scanning Calorimetry

For differential scanning calorimetry (DSC), duplicate runs of refined liquid palm oil and oleogel samples were performed on a DSC Polyma 214 differential scanning calorimeter (NETZSCH, Selb, Germany). Aluminum Concavus® pans with pierced lids were used. Every sample pan was run against a calibrated, empty reference pan with pierced lid. In each run, the weight of oleogel sample was kept at 13.0-14.0 mg; the weight of refined liquid palm oil sample was within 9.6-13.8 mg. The DSC methods were modified from Dodd and Tonge [Dodd J. W. and Tonge K. H. Thermal Methods, Wiley, London (1987)].

For the determination of the enthalpy of fat crystallisation, the sample pans were equilibrated at 20° C. for 5 min, and then cooled to −30° C. at a cooling rate of 20° C.·min⁻¹. Such a relatively fast cooling rate was used to augment any difference in enthalpies of fat crystallisation for detection. The enthalpy of fat crystallisation was calculated from the integrated DSC curves at 5 to -20° C., using the complex peak function in the Proteus Analysis software (version 7) and with a width setting of 15. Artifact signal at higher temperatures caused by the sudden fast cooling was not used. For understanding the melting characteristics of fat, the sample pans were equilibrated at 20° C. for 5 min, cooled to −30° C. at a cooling rate of 5° C.·min⁻¹ maintained at −30° C. for 5 min, and then warmed back to 20° C. at a heating rate of 5° C.·min⁻¹. The relatively slow rate in temperature change was meant to obtain pronounced melting peaks to detect nuanced differences in fat melting behaviour. In both setups, the gas flows for purge nitrogen and protective nitrogen were maintained at 40 mg·ml⁻¹ and 60 mg·ml⁻¹, respectively.

### Assessment of Thermal Stability of Oleogel

5 g of each oleogel sample, contained in a 50-mL centrifuge tube, was equilibrated in a water bath set at the temperature of interest for at least 30 min, and immediately photographed. The tested temperatures were from 30° C. to 70° C. All photography was done against a black backdrop within an ESDDI LED shooting tent kit (Aukey, Shenzhen, China), using a DSLR EOS 800D camera and EF-S 18-55 mm lens (Canon, Tokyo, Japan), with settings of f11.0 aperture, ISO 100, and exposure −1 to 0.

### Statistical Analysis

Statistical analysis was performed using an online calculator for one-way analysis of variance (ANOVA) with post-hoc multiple comparison, including Tukey's honest significant difference test and Holm-Bonferroni test [Vasavada, N. https://astatsadotcom/OneWay_Anova_with_TukeyHSD/(2019)].

### EXAMPLE 2

### Effect of Homogenisation Pressure and Number of Passes on the Viscosity of Aqueous Fibre Dispersions

Our understanding of the shear-activation of the fibres in aqueous dispersion form is that aggregates present in the dispersion were disrupted, more hydroxyl groups became exposed to interact with water through hydrogen bonds, and more dispersed and finer type of aggregates were attained. Without being bound by theory, it is possible the reformation of the aggregates through network formation, possibly by hydrophobic interactions, was responsible for the apparent increase in the aqueous viscosity of the dispersion. This is shown in Table 1, and generally, the higher the homogenising pressure and the number of homogenising passes, the higher the viscosity. This was more apparent in the citrus fibres than in the Nata de coco fibre mix; for the latter it seemed that three homogenising passes were adequate for the aqueous viscosity to plateau. Table 1 also shows that it is possible to attain a viscosity within a certain range by manipulating the homogenising pressure and number of homogenising passes.

TABLE 1
Viscosity readings of aqueous fibre dispersions prepared at different concentrations
and homogenised at different pressures and number of passes.

| | | Number of | Viscosity (mPa · s) [at average | | |
|---|---|---|---|---|---|
| | Homogenising | homogenising | 23° C. room temperature] | | |
| Aqueous fibre dispersion | pressure (bar) | passes | 1 | 2 | Average |
| 2.0% citrus fibre 100M40 | 50 | 3 | 108 | 100 | 104 |
| [0.83% insoluble fibre + 0.69% | | 5 | 155 | 140 | 148 |
| soluble fibre] | | 7 | 247 | 206 | 227 |
| | | 10 | 236 | 225 | 231 |
| 1.5% citrus fibre 100M40 | 120 | 3 | 111 | 103 | 107 |
| [0.62% insoluble fibre + 0.52% | | 5 | 231 | 194 | 213 |
| soluble fibre] | | 7 | 327 | 289 | 308 |
| | | 10 | 412 | 383 | 398 |
| 1.5% citrus fibre 100M40 | 50 | 3* | 39.3 | 37.8 | 38.6* |
| [0.62% insoluble fibre + 0.52% | | 5 | 59.9 | 61.6 | 60.8 |
| soluble fibre] | | 7 | 78.5 | 77.4 | 78.0 |
| | | 10 | 133 | 97.5 | 115 |
| 2.0% citrus fibre 100M20 | 50 | 3* | 27.7 | 25.5 | 26.6* |
| [0.83% insoluble fibre + 0.69% | | 5 | 30.4 | 30.1 | 30.3 |
| soluble fibre] | | 7 | 34.3 | 32.6 | 33.5 |
| | | 10 | 38.0 | 37.9 | 38.0 |
| 1.5% citrus fibre 100M20 | 140 | 3 | 12.4 | 12.7 | 12.6 |
| [0.62% insoluble fibre + 0.52% | | 5 | 19.1 | 19.7 | 19.4 |
| soluble fibre] | | 7 | 26.2 | 24.8 | 25.5 |
| | | 10* | 30.3 | 31.6 | 31.0* |
| 1.5% citrus fibre 100M20 | 120 | 3 | 12.6 | 12.1 | 12.4 |
| [0.62% insoluble fibre + 0.52% | | 5 | 22.7 | 16.3 | 19.5 |
| soluble fibre] | | 7 | 30.8 | 22.9 | 26.9 |
| | | 10 | 31.1 | 29.4 | 30.3 |
| 2.0% nata de coco mix | 50 | 3* | 24.3 | 24.9 | 24.6* |
| [0.82% nata de coco insoluble | | 5 | 23.9 | 24.4 | 24.2 |
| fibre + 1.18% corn soluble | | 7 | 24.5 | 24.2 | 24.4 |
| fibre] | | 10 | 23.5 | 23.9 | 23.7 |
| 1.5% nata de coco mix | 120 | 3 | 14.7 | 14.7 | 14.7 |
| [0.62% nata de coco insoluble | | 5 | 14.0 | 14.5 | 14.3 |
| fibre + 0.89% corn soluble | | 7 | 13.6 | 13.8 | 13.7 |
| fibre] | | 10 | 13.0 | 13.1 | 13.1 |

The asterisk * represents the combination of parameters selected for the subsequent making of oleogel samples.

### EXAMPLE 3

### Surface or Interfacial Tension Between Fibre Dispersions and Air/Oil and Water

Table 2 provides an understanding of how the shear-activated fibres reduced the repulsion between surface molecules of air/oil and water. Two inferences could be made. First, from Group 1 of Table 2, which compares the fibres under the same homogenising conditions, citrus fibre 100M40 had the highest affinity to oil, followed by citrus fibre 100M20, and finally the Nata de coco fibre mix. The differences were significant at p<0.05. Second, from Groups 2 and 3 of Table 2, an increase in the homogenising pressure from 50 to 140 bar and an increase in the number of passes from 3 to 10 did not significantly alter the hydrophobicity of citrus fibre 100M20.

TABLE 2
Surface/Interfacial tension readings between aqueous fibre dispersions
and air/refined liquid palm oil, at room temperature.

| | | | | Surface/Interfacial tension | | | | |
|---|---|---|---|---|---|---|---|---|
| | | Sample of aqueous | Homogenisation | (mN · m⁻¹) | | | | |
| Group | Interface | fibre dispersion | conditions | 1 | 2 | 3 | Average | |
| 1 | Oil-aqueous | 2.0% citrus fibre 100M40 | 50 bar, 10 passes | 1.36 | 1.14 | 2.00 | 1.50 | a |
| | | [0.83% insoluble fibre + | | | | | | |
| | | 0.69% soluble fibre] | | | | | | |
| | | 2.0% citrus fibre 100M20 | 50 bar, 10 passes | 4.49 | 3.83 | 4.76 | 4.36 | b |
| | | [0.83% insoluble fibre + | | | | | | |
| | | 0.69% soluble fibre] | | | | | | |
| | | 2.0% nata de coco mix | 50 bar, 10 passes | 5.36 | 5.42 | 5.31 | 5.36 | c |
| | | [0.82% nata de coco | | | | | | |
| | | insoluble fibre + 1.18% | | | | | | |
| | | corn soluble fibre] | | | | | | |
| 2 | Oil-aqueous | 2.0% citrus fibre 100M40 | 50 bar, 3 passes | 2.48 | 2.05 | 3.16 | 2.56 | a |
| | | [0.83% insoluble fibre + | | | | | | |
| | | 0.69% soluble fibre] | | | | | | |
| | | 2.0% citrus fibre 100M20 | 50 bar, 3 passes | 5.15 | 5.42 | 5.14 | 5.24 | b |
| | | [0.83% insoluble fibre + | 140 bar, 10 | 4.42 | 3.68 | 5.20 | 4.43 | b |
| | | 0.69% soluble fibre] | passes | | | | | |
| 3 | Air-aqueous | 2.0% citrus fibre 100M40 | 50 bar, 3 passes | 48.27 | 46.53 | 48.93 | 47.91 | a |
| | | [0.83% insoluble fibre + | | | | | | |
| | | 0.69% soluble fibre] | | | | | | |
| | | 2.0% citrus fibre 100M20 | 50 bar, 3 passes | 52.90 | 53.86 | 53.41 | 53.39 | b |
| | | [0.83% insoluble fibre + | 140 bar, 10 | 54.73 | 52.84 | 50.24 | 52.60 | b |
| | | 0.69% soluble fibre] | passes | | | | | |

Different letters in each group denote significant differences among all pairs of samples, based on Tukey's honest significant difference test at p < 0.05.

As the emulsification of oil and the fibre dispersion preceded other steps in the oleogel-making, the viscosity of the fibre dispersion posed as an influencing factor on the microstructure in the emulsion, which in turn could have implication on the properties of the oleogel. In order to determine the effect of the main factors of interest, e.g. powder particle size of fibre and nature of fibre, the viscosity of the fibre dispersion was kept constant. From Table 1, a few combinations of parameters which could allow pairwise comparison were identified (marked with asterisks), as elaborated in Table 3. Table 3 highlights the factors that were tested, namely powder particle size of fibre, nature of fibre, and type of oil. A fourth test factor not stated in Table 3 was the method of oleogel preparation.

TABLE 3
Specific fibre-based oleogel samples prepared for pair comparison, as informed
by the viscosity readings of aqueous fibre dispersions in Table 1.

| Oleogel sample | | Factor of |
|---|---|---|
| (jammed emulsion-templated) | Invariable factors | comparison |
| Citrus fibre 100M40 + refined liquid palm | Nature of fibre | Powder particle |
| oil [From 1.5% citrus fibre dispersion | Percentage of solids | size of fibre |
| (38.6 mPa s)] | Percentage of | |
| | insoluble fibre | |
| Citrus fibre 100M20 + refined liquid palm | Type of oil | |
| oil [From 1.5% citrus fibre dispersion | Viscosity of dispersion | |
| (31.0 mPa s)] | (30-40 mPa s) | |
| Citrus fibre 100M20 + refined liquid palm | Percentage of solids | Nature of fibre |
| oil [From 2.0% citrus fibre dispersion | Percentage of | |
| (26.6 mPa s)] | insoluble fibre | |
| Nata de coco mix + refined liquid palm oil | Type of oil | |
| [From 2.0% nata de coco mix dispersion | Viscosity of dispersion | |
| (24.6 mPa · s)] | (20-30 mPa s) | |
| Citrus fibre 100M20 + refined liquid palm | Nature of fibre | Type of oil |
| oil [From 2.0% citrus fibre dispersion | Percentage of solids | |
| (38.0 mPa s)] | Percentage of | |
| | insoluble fibre | |
| Citrus fibre 100M20 + olive oil | Viscosity of dispersion | |
| [From 2.0% citrus fibre dispersion | Particle size of fibre | |
| (38.0 mPa s)] | | |

### EXAMPLE 4

### Microstructure of Fibre-Based Oleogels

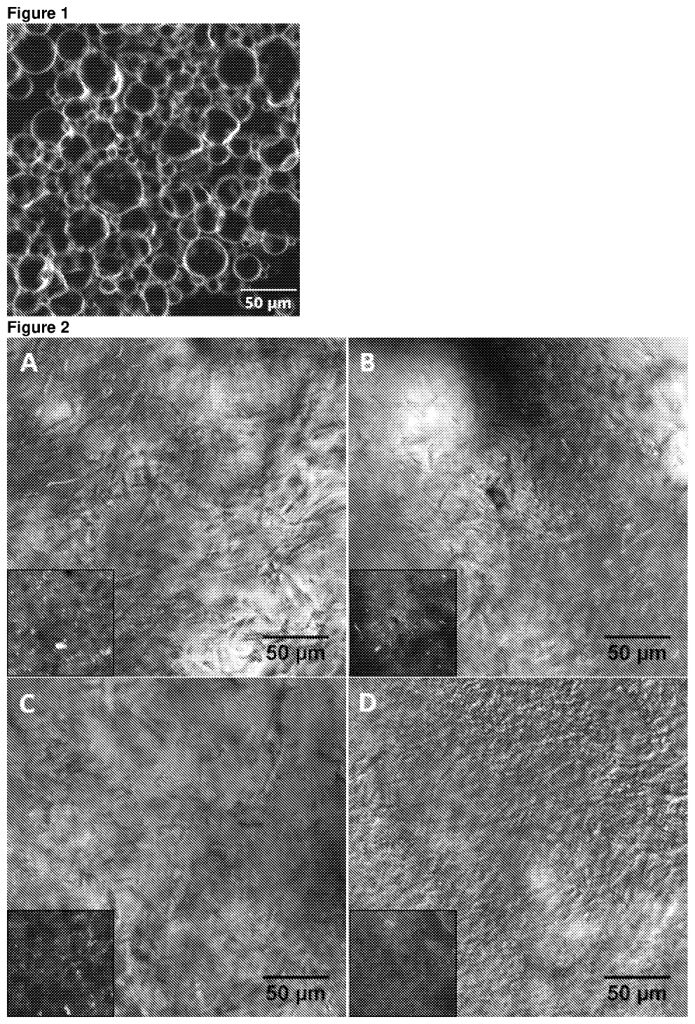

An emulsion microstructure attained in our sample preparation, which exemplifies random close packing of the dispersed phase surrounded by a continuous oil phase and stabilised by fibre is depicted in FIG. 1. Therefore, the method which we had developed for fibre-based oleogel-making was aptly termed as a jammed emulsion-templated method, based on which some of the oleogels listed in Table 3 were prepared and imaged (FIG. 2). FIG. 2 shows that the oil was well dispersed throughout the fibrous network in every oleogel sample. The Nata de coco fibre mix depicted a finer but more extensive network than citrus fibre. Among the citrus fibre oleogels, the fibre strands were more distinct in the citrus fibre 100M40 oleogel sample (FIG. 2A), while those in citrus fibre 100M20 oleogel samples were more fragmented (FIGS. 2B and C). Increased shear-activation from more intensive homogenisation had an impact on the fibre network (FIG. 2C compared to FIG. 2B). Despite the same powder particle size of fibre from the same starting powder material, a more reticulated network could be achieved.

### EXAMPLE 5

### Thermal Properties of Fibre-Based Oleogels

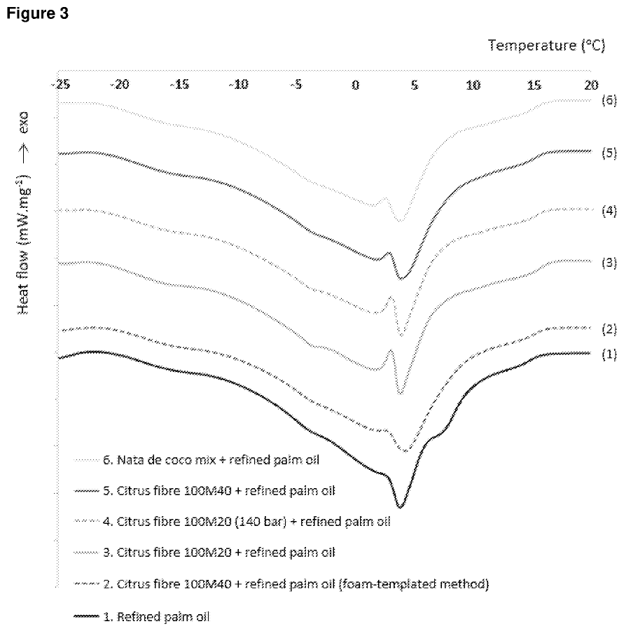

The refined liquid palm oil used in this study contained 63% unsaturated fat according to its nutrition label. The composition of the oil resembled palm olein, which reportedly has around 58% unsaturated fat content (C18:1, C18:2, and C18:3 combined) [Nassu, R. T. and Guaraldo Goncalves, L. A. Graas y Aceites 50: 16-21 (1999)], a peak melting temperature of 4° C. from DSC analysis [Nassu R. T., and Guaraldo Goncalves L. A., Grasas y Aceites, 50: 16-21 (1999)], and a mean solid fat content of 5.7% at 20° C. [Siew, W. L., et al., Journal of Oil Palm Research 5: 38-46 (1993)]. According to FIG. 3 and Table 4 which show samples having the same thermal histories, the presence of fibre in the jammed emulsion-templated oleogels disrupted fat crystallisation, leading to proportionately more crystal species that were less stable. As expected, the refined liquid palm oil showed only one dominant endothermic peak for melting at 3.85° C., but with the presence of fibre, a smaller second endothermic peak at a lower temperature appeared (FIG. 3). Apparently, the dimensions of the fibre mattered. The main melting peak was still fairly prominent in the citrus fibre 100M20 oleogels, especially when shear-activation was done at 50 bar. However, when the fibres were longer or more extensive (i.e. in the case for citrus fibre 100M40 and Nata de coco fibre mix) and therefore more penetrative, the main melting peak became relatively less distinct. Similarly, oleogels made with the citrus fibre 100M40 and Nata de coco fibre mix displayed significantly lower (p<0.05) enthalpies of fat crystallisation (i.e. 22.34-24.13 J·g⁻¹) relative to the refined liquid palm oil control, whereas the citrus fibre 100M20 oleogels displayed relatively higher enthalpies (i.e. 27.35-31.01 J·g⁻¹). On comparing the cryogel foam-templated oleogel of citrus fibre 100M40 with its jammed emulsion-templated counterpart, there appeared to be less disruption of fibre on fat crystallisation in the former. For the cryogel foam-templated oleogel, the aforementioned second melting peak barely surfaced, and its enthalpy of fat crystallisation was higher (i.e. 25.42 vs 23.80 J·g⁻¹ in average values).

TABLE 4
Enthalpies of fat crystallisation of oil and fibre-based oleogels, calculated from integrated
differential scanning calorimetry (DSC) cooling thermograms at 20° C. min⁻¹ rate.
Different letters denote significant differences in oleogel samples relative to the oil
control in a simultaneous comparison, based on Holm-Bonferroni test at p ≤ 0.05.

| | Method of | Enthalpy of fat crystallisation (J g⁻¹) | | | |
|---|---|---|---|---|---|
| | oleogel | [−20 to 5° C.] | | | |
| Oil/oleogel sample | preparation | 1 | 2 | Average | |
| Refined liquid palm oil (control) | — | 30.09 | 28.51 | 29.30 | a |
| Citrus fibre 100M40 + refined liquid | Cryogel | 26.32 | 24.51 | 25.42 | a |
| palm oil [from 1.5% citrus fibre | foam- | | | | |
| dispersion (38.6 mPa s)] | templated | | | | |
| Citrus fibre 100M40 + refined liquid | Jammed | 23.62 | 23.98 | 23.80 | b |
| palm oil [from 1.5% citrus fibre | emulsion- | | | | |
| dispersion (38.6 mPa s)] | templated | | | | |
| Citrus fibre 100M20 + refined liquid | Jammed | 27.99 | 31.01 | 29.50 | a |
| palm oil [from 1.5% citrus fibre | emulsion- | | | | |
| dispersion (31.0 mPa s)] | templated | | | | |
| Citrus fibre 100M20 + refined liquid | Jammed | 28.66 | 27.35 | 28.01 | a |
| palm oil [from 2.0% citrus fibre | emulsion- | | | | |
| dispersion (26.6 mPa s)] | templated | | | | |
| Nata de coco mix + refined liquid palm | Jammed | 22.34 | 24.13 | 23.24 | b |
| oil [from 2.0% nata de coco mix | emulsion- | | | | |
| dispersion (24.6 mPa s)] | templated | | | | |

### EXAMPLE 6

### Spreadability of Fibre-Based Oleogel

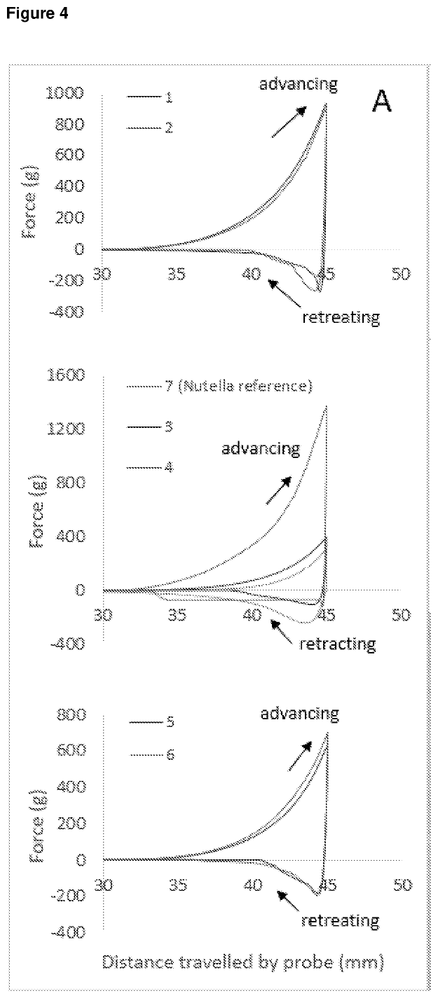

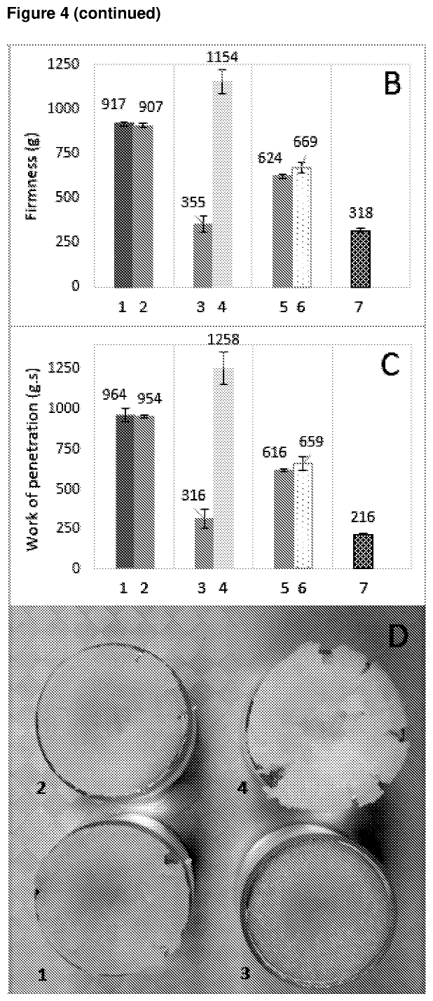

Despite the greater disruption on fat crystallisation, oleogels made with longer and/or more extensive fibres were firmer and less spreadable at room temperature. FIG. 4A shows the force-distance curves of oleogels analysed by the spreadability test. FIGS. 4B and C, which are based on FIG. 4A, compare pairs of jammed emulsion-templated oleogels to understand the influence of fibre powder particle size (i.e. samples 1 vs 2, from 30-40 mPa·s fibre dispersions), nature of fibre (i.e. samples 3 vs 4, from 20-30 mPa·s fibre dispersions), and type of oil (i.e. samples 5 vs 6, made from refined liquid palm oil and olive oil, respectively). In terms of firmness, the citrus fibre oleogels from 100M40 and the highly shear-activated 100M20 were considerably high and comparable. The oleogel from the less shear-activated citrus fibre 100M20 was the least firm among the different oleogels, and had fairly similar spreadability as the commercial Nutella® spread. The type of oil used did not result in significant difference in spreadability. The Nata de coco fibre mix oleogel was the firmest but at the same time displayed the highest plasticity, as it retained its deformation the most after the load for testing spreadability was removed (FIG. 4D).

### EXAMPLE 7

### Apparent Melting Profiles of Fibre-Based Oleogels

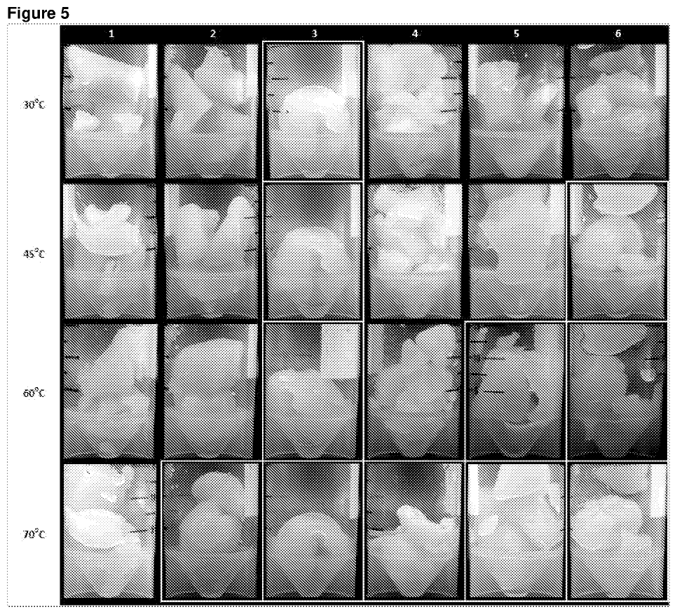

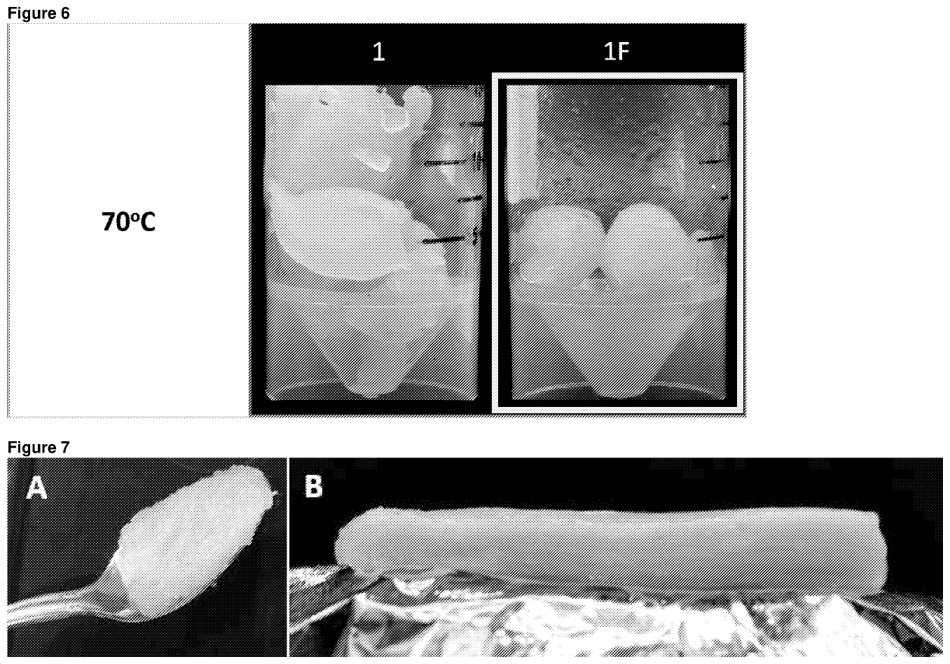

The true peak melting temperatures of the entrapped fat in the oleogels was not significantly altered (FIG. 3), but the oleogels started melting apparently at much higher temperatures (FIG. 5). This was believed to be influenced by the microstructural fibre scaffold. The oleogel from the less shear-activated citrus fibre 100M20 (i.e. from 26.6 mPa·s fibre dispersion) exhibited the lowest thermal stability, apparently melting at 30° C. With more intense shear-activation, the citrus fibre 100M20 oleogel (from 31.0 mPa·s fibre dispersion) stayed thermally stable till 60° C. The citrus fibre 100M40 oleogel was the most thermally stable, without any oil oozing from the structure even at 70° C. Interestingly, although the Nata de coco fibre mix oleogel was the firmest and least spreadable, it collapsed into a pool of oil at 70° C. For the citrus fibre 100M20 oleogels created from 38.0 mPa·s fibre dispersion, the one comprising olive oil had apparently melted at 45° C., while the one comprising refined liquid palm oil showed apparent melting only at 60° C. and above. Finally, the cryogel foam-templated oleogel made from citrus fibre 100M40 was not able to stay thermally stable at 70° C., compared to its corresponding sample derived from jammed emulsion (FIG. 6). No clear difference in the apparent melting behaviour was noted in both samples at 60° C. and below; neither was there noticeable difference between other pairs of cryogel foam-templated and jammed emulsion-templated oleogels having the same ingredient composition, at 30-70° C. (data not shown).

### EXAMPLE 8

### Design of the Production Steps for Fibre-Based Oleogel to Influence its Microstructure

The network structure of the food fibres is hypothesized to have paramount influence on the oil-binding capability within the oleogel. For producing an oleogel having maximal possible strength and oil retention, it is ideal if the oil molecules are homogeneously distributed to close proximity of the fibre network structure before the latter becomes set. With this consideration we present a way of oleogel creation, with the main oleogel samples being derived from jammed emulsions characterized by random close packing of the dispersed phase droplets (depicted in FIG. 1). Bordering on being categorised as high internal phase emulsions (HIPEs), the emulsion samples comprised of 67-73% aqueous dispersed phase and 27-33% oil continuous phase on weight basis. Almost every aqueous droplet touched neighbouring aqueous droplets, and they were separated by a thin layer of oil continuous phase as stained by Nile Red (FIG. 1). In such physical assembly, the fibre strands likely remained randomly dispersed throughout the emulsion and at the oil-aqueous interface. Then, the oil would be in close proximity at the micrometer scale to fill the void left by the sublimed water after freeze-drying (FIGS. 2A-D).

The making of a w/o jammed emulsion to yield a solid-like matrix containing oil is not new. This has been previously demonstrated by Patel et al. [Patel, A. R. et al., RSC Advances 4: 18136-18140 (2014)], who relied on gelled dispersed phase droplets of synergistic hydrocolloids to hold the continuous oil phase within the interstitial spaces. For their method to work, Patel et al. (2014) also used the non-natural emulsifier polyglycerol polyricinoleate, with a HLB (hydrophilic-lipophilic balance) that could be as low as 0.6 [Min, J. Y., et al., Food Science and Technology 38: 485-492 (2018)]. The novelty and elegance of the fibre-based oleogel presented in our work is that the use of natural, cellulosic food fibres alone sufficed, without having to rely on other emulsifiers. The function of the fibre strands was two-fold: first, they probably stabilized the jammed emulsion from which the oleogel was derived; second, they provided the skeletal structure for holding the oleogel. Here, the use of high temperature, chemical modification, or a second compatible biopolymer to reinforce the skeletal network, as in the cases with cross-linked protein [Romoscanu, A. I. and Mezzenga R. Langmuir 22: 7812-7818 (2006)] and protein-carbohydrate complexation [Patel, A. R. et al., Langmuir 31: 2065-2073 (2015); Tavernir, I., et al., Food Colloids 65: 107-120 (2017); Wijaya, W., et al., (2017)] is not necessary.

### EXAMPLE 9

### Factors Influencing Oil-Holding and Structural Strength in Fibre-Based Oleogel

A non-aqueous matrix system of passing resemblance to the fibre-based oleogel matrix is the chocolate matrix. The chocolate matrix has been studied for the particle size effect on fat movement (i.e. the phenomenon of fat bloom). While the cases of filled chocolate are complicated by pressure differences which drive molecular diffusion and convective flow [Dahlenborg, H., et al. Journal of Food Engineering 146: 172-181 (2014)], few studies on plain chocolate provide thought-provoking references. When the chocolate matrix was equilibrated near its melting point, non-fat particles nearing 10 μm in size might acquire high enough Brownian motion [Genovese, D. B., et al., Journal of Food Science 72: R11-R20 (2007)] to displace neighbouring liquid fat molecules and promote significant fat movement [Altimiras, R., et al., Journal of Food Engineering 80: 600-610 (2007)]. The presence of such small particles alone might also entail substantial surface area to curb the growth of fat crystal clusters, leading to a heterogeneous matrix system of higher permeability for less stable triacylglycerols to flow [Dahlenborg, H., et al., Journal of Food Engineering 146: 172-181 (2015); Motwani, T., et al., Journal of Food Engineering 104: 186-195 (2011)]. Beyond this size, hydrodynamic flow dominates rheology rather than Brownian motion. For instance, when comparing non-fat particles of ˜20 μm versus ˜50 μm in D₉₀, the group of larger particles led to experimental indications of significantly greater fat movement [Zhao, H., et al., Journal of Food Engineering 225: 12-17 (2018); Afoakwa, E. O., Journal of Food Engineering 91: 571-581 (2009)]. In fact, by preparing matrices with a fat content as high as 68% on weight basis, fat migration was already significantly faster at a D₉₀ particle size of ˜40 μm [Zhao, H. et al., Journal of Food Engineering 225: 12-17 (2018)]. The authors reasoned that the larger particle sizes caused lower packing density, and hence wider inter-particle channels for the capillary migration of fat. This would be in accordance to the capillary theory as essentiated in the Lucas-Washburn equation, which defines the migration rate of a fluid to be higher in ideal capillaries of wider dimensions.

However, in the case of the fibre-based oleogel samples, the above discussed mechanisms might not be applicable. First of all, even though, as depicted in FIG. 2, the characteristic dimensions of the tested fibres was below 10 μm, the fibre strands were immobile under video DIC microscopy (at 22° C., with a 60× magnification oil lens, and a “zoom optimise” setting of 4.41; data not shown). Second, the mass fraction of the fibres was only 4%, unlike in the aforementioned studies on chocolate with the mass percentage of non-fat solids at 32-73%. Third, as shown by the DSC melting thermograms (FIG. 3), the fat in the oleogel samples was essentially in liquid state at and above 20° C., during which there was no fat crystal involved to affect fat movement. Therefore, the difference in the apparent melting behavior of the oleogels (FIG. 5) might be attributed to other mechanisms, dependent on factors which are discussed below.

### EXAMPLE 10

### Comparison on the Nature of Oleogel Fibre

As suggested in Table 2, the Nata de coco fibre mix had the highest affinity to water. It would be conceivable that it retained bound water the most after the freeze-drying process during oleogel production. Thus, it is postulated that despite more total surface area, its surface would pose less adhesive attraction for the oil, meaning less friction to resist flow (viscous drag). Nonetheless, at 60° C. and below, the oil remained confined in the network of the Nata de coco fibre mix. We suggest this might be due to the exceptionally high tortuosity which retarded capillary flow. This might help explain the greater ability of the Nata de coco fibre mix oleogel to retain solid-like property than its citrus fibre 100M20 oleogel counterpart, as shown in FIG. 5 (samples 3 and 4).

The collapse of the fibre network and separation of oil in the Nata de coco fibre mix oleogel at 70° C. was rather drastic. Oil viscosity is unlikely to change dramatically between 60 and 70° C., hence it is unlikely that the effect of gravity would become overwhelming to drive gravitational compaction of the fibre network. Among the oleogel samples at room temperature, the solid-like Nata de coco fibre mix oleogel (FIG. 4D, sample 4) displayed plasticity in flow behavior and retained deformation the most after compression in the spreadability test. It is likely that its thin fibres were more prone to plasticisation by the oil and softened at 70° C., such that they could aggregate together to drive the collapse of the network.

### EXAMPLE 11

### Comparison on the Particle Size of (Citrus) Fibre

The capillary theory might have limited participation in the case of the citrus fibre-based oleogels. As seen in FIG. 2, compared to the fibre network in Nata de coco mix oleogel, those in the citrus fibre oleogels were less intricate and had thicker strands spaced wider apart at the micrometre scale. While this might appear to pose less obstruction in passages for oil flow (relative to the Nata de coco oleogel), it actually did not undermine the ability of citrus fibre to trap oil in solid-like oleogel form, especially 100M40 (FIG. 5, sample 1). Microrheology of the entrapped oil was attempted to infer, via Stokes-Einstein relation, its viscosity from the tracked random movement of dosed, non-aggregating fluorescent particles [Moschakis T., et al., Langmuir, 22: 4710-4719 (2006)]. However, this was found to be complicated by the tendency of the citrus fibre, with inherent protein at ˜7% (according to product specifications), to associate with the negatively charged microspheres (potentially due to electrostatic attraction). In other words, the reliability of the microspheres as an indicator of oil diffusion in the oleogel was uncertain.

To consolidate the results thus far, among the citrus fibre-based oleogel samples, the citrus fibre 100M40 oleogel originating from the coarser powder (particle size below 74 μm) had longer fibre strands and a more reticulated network. It also had high structural strength and good thermal stability even at 70° C. In contrast, the citrus fibre 100M20 oleogel originating from a finer powder (particle size below 12 μm) and made under the same homogenising conditions (50 bar, 3 passes) had more fragmented fibre strands. It had the softest texture, and its loose fibre network was unable to stop the entrapped oil from oozing out at 30° C. and above. However, when citrus fibre 100M20 was more shear-activated (i.e. at 140 bar, 10 passes), although there was insignificant change in surface activity (Table 2), its oleogel had very different properties. A more extensive fibre network in the citrus fibre 100M20 oleogel was yielded, its heat tolerance increased to 60° C., and it had comparable structural strength as the citrus fibre 100M40 oleogel. Conceivably, on the physical properties of the citrus fibre-based oleogels, it was the eventual dimensions of the fibre strands after homogenisation which mattered, rather than the starting fibre powder particle size.

Considering the qualitative difference in the roughness or intricacy of fibre networks in the citrus fibre-based oleogels (FIGS. 2A-C), we postulate that oil entrapment in oleogel might be related to wetting of the fibre strands by oil. The citrus fibre 100M40 oleogel could be imagined as a stack of x-y planes comprising regions akin to Cassie impregnating wetting regimes, in the three-dimensional space. Greater degree of oil wetting is suggested to stem from greater area of roughness in the plane: when fibres are longer and/or more intricate in layout, they provide greater anchorage for the oil. The suggested relevance of Cassie impregnating wetting is drawn from the example of a rose petal having surface microstructures at a similar scale of length [Feng L., et al., Langmuir, 24: 4114-4119 (2008)]. The micropapillae on the petal surface were a few microns high and had peaks spaced 10-20 μm apart. In spite of the superhydrophobicity of the petal surface, it was able to keep small water droplets spherically pinned even when turned upside down.

### EXAMPLE 12

### Comparison of Oil Type on Oleogel-Making Method

The inherent nature of the oil apparently influenced oil-holding and structural strength in the fibre-based oleogel. This was evident in FIG. 5, when comparing sample 5 (composed of refined liquid palm oil) and sample 6 (consisting of olive oil). In both samples, other factors such as the oleogel preparation method, nature of fibre, powder particle size of fibre, and mass fractions of the fibre and oil were kept constant. From the nutritional labels, the refined liquid palm oil and olive oil used in this study comprised 61% and 73% total unsaturated fats on weight basis, respectively. It is reasoned that in olive oil, there are more double bonds to cause kinks in the carbon chains, leading to less cohesion among the oil molecules (as reflected by a lower empirical freezing point) and more ease in flow through the fibre network.

The oleogel samples derived from jammed emulsions were compared with corresponding oleogel samples prepared from a cryogel foam-based method as pioneered by Patel et al [Patel, A. R., et al., RSC Advances 3: 22900-22903 (2013)]. In the latter approach, porous cryogels were first created by freeze-drying the fibre dispersions, by which liquid oil was then absorbed. The effect of the method was contrasting enough only in the citrus fibre 100M40 oleogel, the most thermally stable among the tested oleogels (FIG. 5). From the comparison of samples at 70° C., the jammed emulsion-template method appeared to have an edge over the cryogel foam-based method (FIG. 6). It might be that, during the making of the jammed emulsion, the action of shearing the fibre dispersion and the oil together promoted homogeneous distribution of the oil through the matrix. In contrast, this might not be attained to the same extent with the passive diffusion of oil in the making of the cryogel-based oleogel. Compared to its jammed emulsion-templated counterpart, the cryogel-based 100M40 oleogel showed higher enthalpy of fat crystallization (Table 4) and closer resemblance in its melting endotherm with that of pure oil (FIG. 3). These indicated less overall physical interaction between oil and fibre in the cryogel-based oleogel. A previous preliminary work with hydroxypropyl methylcellulose (HPME) also added weight to this suggestion. On its own, HPME carries a chemical, peppery smell. In the emulsion-templated method, no distinct smell was perceived from HPME-based oleogel, whereas in the cryogel-based method, the peppery smell could not be masked by the oil.

### EXAMPLE 13

### Feasibility of Scale-Up in Fibre-Based Oleogel Production

In this work, the process of creating a fibre-based oleogel from a jammed emulsion template is easily attainable, using modest kinetic energy input and without using heat. To make either firm or spreadable oleogels, a homogenising pressure of 50-140 bar proved to be sufficient for shear-activating the food fibres, which is lower than that typically used for industrial milk homogenisation (i.e. 200-250 bar). Prior to freeze-drying, freezing of the emulsion is involved. The typical timescales associated with modern day industrial freezing methods should not pose a challenge, due to attainable emulsion stability. In fact, the weakest oleogel as observed in FIGS. 4A-C, i.e. the citrus fibre 100M20 oleogel formed from refined liquid palm oil and 26.6 mPa·s fibre dispersion, could remain visibly stable at room temperature without phase separation for at least 4 h. The structural stability in the jammed emulsion arose from the random close packing configuration (FIG. 1), with severe restriction in the movement of the dispersed phase droplets [Mason, T. G., et al. Langmuir 24: 4114-4119 (2008)]. As seen in FIG. 1, with the compression among the aqueous dispersed phase droplets, the surface of some of them was not round but deformed. This gain in interfacial area resulted in the storage of elastic energy in the droplets [Mason, T. G., et al. Langmuir 24: 4114-4119 (2008)], which manifested into reduced fluidity and emulsion stability. Contributing also to emulsion stability was the viscosity of the aqueous phase itself, which was developed during shear activation of the fibre (especially citrus fibre). As matters stand, microwave-assisted freeze-drying, which introduces mild locale heating to the dehydration process, may be a useful drying alternative for energy savings.

### SUMMARY

The present invention provides a novel approach to developing oleogels involving no heat in its development. It shear-activates insoluble, natural food fibres from citrus source or Nata de coco to form a fibre matrix where the oil is entrapped. Oleogels of the invention can be made without oiling off on low compression force, and that the manufacturing conditions can be manipulated for the oleogels to have similar rheological properties as target products, for instance a soft breakfast spread (FIG. 7A), or a bakery margarine which is structurally stronger to tolerate physical shear at moderate temperature (FIG. 7B). From the experimental findings, it is believed that the physical properties of the oleogels are influenced by the fibre network, and the oil is just a filler and possibly softener of the fibres. Broadly, oleogels made with longer or more extensive fibres are firmer and more able to retain the oil in solid oleogel form. Products of the invention may have nutritional and clinical application for lipidemic control.

### REFERENCES

1 Afoakwa E. O., Paterson A., Fowler M., and Vieira J., Fat bloom development and structure-appearance relationships during storage of under-tempered dark chocolates, Journal of Food Engineering, 2009, 91: 571-581.
2 Alves L., et al., On the role of hydrophobic interactions in cellulose dissolution and regeneration: Colloidal aggregates and molecular solutions, Colloids and Surfaces A: Physicochemical and Engineering Aspects, 2015, 483: 257-263.
3 Altimiras P., Pyle L., and Bouchon P., Structure—fat migration relationships during storage of cocoa butter model bars: Bloom development and possible mechanisms, Journal of Food Engineering, 2007, 80: 600-610.
4 Berry J. D., Neeson M. J., Dagastine R. R., Chan D. Y. C., and Tabor R. F., Measurement of surface and interfacial tension using pendant drop tensiometry, Journal of Colloid and Interface Science, 2015, 454: 226-237.
5 Co E. D., and Marangoni A. G., in Edible Oleogels (Second Edition), eds. A. G. Marangoni and N. Garti, AOCS Press, 2018, pp. 1-29.
6 Dahlenborg H., Millqvist-Fureby A., and Bergenståhl B., Effect of particle size in chocolate shell on oil migration and fat bloom development, Journal of Food Engineering, 2015, 146: 172-181.
7 DiNicolantonio J. J., and O'Keefe J. H., Effects of dietary fats on blood lipids: a review of direct comparison trials, Open Heart, 2018, 5: e000871.

### 8 Dodd J. W., and Tonge K. H., Thermal Methods, Wiley, London, 1987.

9 Feng L., Zhang Y., Xi J., Zhu Y., Wang N., Xia F., and Jiang L., Petal effect: A superhydrophobic state with high adhesive force, Langmuir, 2008, 24: 4114-4119.
10 Garti N., Food emulsifiers: Structure-reactivity relationships, design, and applications, CRC Press, Boca Raton, 2002.
11 Genovese D. B., Lozano J. E., and Rao M. A., The rheology of colloidal and noncolloidal food dispersions, Journal of Food Science, 2007, 72: R11-R20.

### 12 Higgins N. W., and Daniels R. L., EP Patent, EP2568818A1, 2011.

13 Japanese Industrial Standard/Japanese Standards Association, JIS Z 8803:2011. Methods for viscosity measurement of liquid (foreign standard), 2011.
14 Martins A. J., Vicente A. A., Cunha R. L., and Cerqueira M. A., Edible oleogels: an opportunity for fat replacement in foods, Food & Function, 2018, 9: 758-773.
15 Mason T. G., Bibette J., and Weitz D. A., Elasticity of compressed emulsions, Physical Review Letters, 1995, 75: 2051-2054
16 Medronho B., and Lindman B., Brief overview on cellulose dissolution/regeneration interactions and mechanisms, Advances in Colloid and Interface Science, 2015, 222: 502-508.
17 Min J. -Y., Ahn Lee Y. -K, Kwak H. -S., and Hyuk Chang Y., Optimized conditions to produce water-in-oil-in-water nanoemulsion and spray-dried nanocapsule of red ginseng extract, Food Science and Technology, 2018, 38: 485-492.
18 Miyamoto H., Rein D. M., et al., Molecular dynamics simulation of cellulose-coated oil-in-water emulsions, Cellulose, 2017, 24: 2699-2711.

### 19 Moschakis T., Murray B. S., and Dickinson E., Particle Tracking Using Confocal Microscopy to Probe the Microrheology in a Phase-Separating Emulsion Containing Nonadsorbing Polysaccharide, Langmuir, 2006, 22: 4710-4719.

20 Motwani T., Hanselmann W., and Anantheswaran R. C., Diffusion, counter-diffusion and lipid phase changes occurring during oil migration in model confectionery systems, Journal of Food Engineering, 2011, 104: 186-195.
21 Napso S., Rein D. M., et al., Structural analysis of cellulose-coated oil-in-water emulsions fabricated from molecular solution, Langmuir, 2018, 34: 8857-8865.
22 Napso S., Rein D. M., et al., Cellulose gel dispersion: From pure hydrogel suspensions to encapsulated oil-in-water emulsions, Colloids and Surfaces B: Biointerfaces, 2016, 137: 70-76.
23 Nassu R. T., and Guaraldo Goncalves L. A., Determination of melting point of vegetable oils and fats by differential scanning calorimetry (DSC) technique, Grasas y Aceites, 1999, 50: 16-21.
24 Patel A. R., Schatteman D., Lesaffer A., and Dewettinck K., A foam-templated approach for fabricating organogels using a water-soluble polymer, RSC Advances, 2013, 3: 22900-22903.
25 Patel A. R., Rodriguez Y., Lesaffer A., and Dewettinck K., High internal phase emulsion gels (HIPE-gels) prepared using food-grade components, RSC Advances, 2014, 4: 18136-18140.

26 Patel A. R., Rajarethinem P. S., Cludts N., Lewille B., De Vos W. H., Lesaffer A., and Dewettinck K., Biopolymer-Based Structuring of Liquid Oil into Soft Solids and Oleogels Using Water-Continuous Emulsions as Templates, Langmuir, 2015, 31: 2065-2073.

27 Rein D. M., Khalfin R., and Cohen Y., Cellulose as a novel amphiphilic coating for oil-in-water and water-in-oil dispersions, Journal of Colloid and Interface Science, 2012, 386: 456-463.
28 Romoscanu A. I., and Mezzenga R., Emulsion-templated fully reversible protein-in-oil gels, Langmuir, 2006, 22: 7812-7818.
29 Siew W. L., Tang T. S., Oh F. C. H., Chong C. L., and Tan Y. A., Identity characteristics of Malaysian palm oil products: fatty acid and triglyceride composition and solid fat content, Journal of Oil Palm Research, 1993, 5: 38-46.
30 Singapore Ministry of Health, Lipids. MOH Clinical Practice Guidelines 2/2016, worldwidewebdotmohdotgovdotsg/docs/librariesprovider4/guidelines/moh-lipids-cpg—booklet.pdf.
31 Smewing J., Texture analysis in action: the TTC spreadability rig, https://textureanalysisprofessionals.blogspot.com/2014/08/texture-analysis-in-action-ttc.html, (accessed 9 Oct., 2019).
32 Tavernier I., Patel A. R., Van der Meeren P., and Dewettinck K., Emulsion-templated liquid oil structuring with soy protein and soy protein: K-carrageenan complexes, Food Hydrocolloids, 2017, 65: 107-120.
33 Totosaus A., Gonzalez L. R., and Fragoso M., Influence of the type of cellulosic derivatives on the texture, and oxidative and thermal stability of soybean oil oleogel, Grasas y Aceites, 2016, 67: e152.
34 Vasavada N., One-way ANOVA (ANalysis Of VAriance) with post-hoc Tukey HSD (Honestly Significant Difference) test calculator for comparing multiple treatments, https://astatsadotcom/OneWay_Anova_with_TukeyHSD/, (accessed 16 Oct., 2019).
35 Wijaya W., Van der Meeren P., and Patel A. R., Oleogels from emulsion (HIPE) templates stabilized by protein-polysaccharide complexes, Royal Society of Chemistry, Cambridge, U.K., 2017.
36 Zhao H., Bingol G., and James B. J., Influence of non-fat particulate network on fat bloom development in a model chocolate, Journal of Food Engineering, 2018, 225: 12-17.

1. A method of preparing an edible oleogel comprising:
a) homogenising an aqueous dispersion of natural and/or naturally derived food fibre a plurality of times to develop viscosity;
b) shear-mixing the aqueous fibre dispersion with liquid edible oil at room temperature, to form an emulsion; and
c) subjecting the emulsion to freeze drying to remove the water.

2. The method of claim 1, wherein the viscosity of the aqueous fibre dispersion is increased by increasing a homogenising pressure and/or by repeating the homogenisation in step a).

3. The method of claim 1, wherein step a) comprises:
i) pre-combining a powder of natural and/or naturally derived food fibre with water and shear-mixing the combination to form a crude dispersion;
ii) homogenising the combination of step i) in a 2-stage homogeniser whereby the second stage pressure is lower than the first stage pressure to form an aqueous fibre dispersion having a viscosity.

4. The method of claim 1, wherein the viscosity of the aqueous fibre dispersion is increased by increasing a homogenising pressure and/or by repeating the homogenisation step aii).

5. The method of claim 1, wherein the homogenising pressure to form the aqueous fibre dispersion is in the range between 25 bar and 160 bar.

6. The method of claim 3, wherein the total homogenising pressure in step aii) is in the range between 25 bar and 160 bar and the pressure applied in the second stage is in the range of 5% to 15% of the total pressure.

7. The method of claim 1, wherein the shear-mixing is performed at about 6000 rpm or higher for about 5 minutes or more.

8. The method of claim 1, wherein step c) comprises subjecting the emulsion to rapid freezing, for instance, via liquid nitrogen freezing, and then freeze drying it.

9. The method of claim 1, wherein the food fibre is an insoluble food fibre or a mixture of insoluble and soluble food fibre.

10. The method of claim 9, wherein the food fibre is a fruit fibre, vegetable fibre, or a bacterial cellulose fibre.

11. The method of claim 10, wherein the food fibre is a citrus food fibre, or nata de coco fibre and a soluble fibre, such as corn fibre.

12. The method of claim 1, wherein the total fibre concentration in the aqueous fibre dispersion is in the range of about 1% to about 5% (w/w), preferably about 1% to about 3% (w/w), more preferably about 1.5% to about v2.0% (w/w).

13. The method of claim 1, wherein for 2.0% and 1.5% fibre dispersions, the preferred dispersion-to-oil ratio is set at 2.0:1 and 2.7:1 (w/w), respectively.

14. The method of claim 1, wherein an oleogel with the rheology of a breakfast spread can be obtained using a citrus fibre (at a powder particle size below 12 μm) at 2.0% (w/w), and by homogenising at 50+5 bar with 3 passes during the preparation of the aqueous fibre dispersion.

15. The method of claim 1, wherein an oleogel with temperature tolerance as high as 70° C. can be obtained using a citrus fibre (at a powder particle size below 74 μm) at 1.5% (w/w), and by homogenising at 50+5 bar with 3 passes during the preparation of aqueous fibre dispersion.

16. The method of claim 1, wherein the liquid edible oil is selected from a group comprising canola oil, corn oil, flaxseed oil, palm oil, olive oil, soybean oil, safflower oil, peanut oil, grape seed oil, sesame oil, argan oil, rice brain oil, avocado oil, mustard oil, algal oil, echium oil, squid oil, salmon oil, halibut oil, fractions and mixtures thereof.

17. An edible oleogel obtained by the method of claim 1, wherein the homogenised aqueous fibre dispersion is shear-mixed with liquid edible oil at room temperature, preferably at a minimum of 6000 rpm for at least 5 minutes to form an emulsion and wherein the oleogel does not contain any emulsifier or surfactant or food polymer in addition to the food fibre and the liquid edible oil is selected from canola oil, corn oil, flaxseed oil, palm oil, olive oil, soybean oil, safflower oil, peanut oil, grape seed oil, sesame oil, argan oil, rice brain oil, algal oil, echium oil, squid oil, salmon oil, halibut oil, fractions and mixtures thereof.

18. The edible oleogel of claim 17, comprising an insoluble fibre component, a soluble fibre component and vegetable oil, wherein the oleogel contains up to about 96% (w/w) oil content.

19. The edible oleogel of claim 17, wherein the insoluble fibre to oil content is up to 1:61 (w/w) after excluding residual bound water.

20. The edible oleogel of claim 17, wherein the insoluble fibre component content in the aqueous fibre dispersion during preparation is in the range of 0.62% to 0.83% (w/w), and the soluble fibre component content in the aqueous fibre dispersion during preparation is in the range of 0.52% to 1.18% (w/w).

21.-23. (canceled)
